(19) United States
(12) Patent Application Publication
(10) Pub. No.: US 2026/0014722 A1
(43) Pub. Date: Jan. 15, 2026

(54) RAZOR ASSEMBLY

(71) Applicant: DORCO CO., LTD., Seoul (KR)

(72) Inventors: Ji Hun KI, Seoul (KR); Sang Hun PARK, Seoul (KR); Da Woon HAN, Seoul (KR)

(21) Appl. No.: 19/337,074

(22) Filed: Sep. 23, 2025

Related U.S. Application Data
(63) Continuation of application No. PCT/KR2024/003979, filed on Mar. 28, 2024.

(30) Foreign Application Priority Data
Mar. 28, 2023 (KR) 10-2023-0040806
May 26, 2023 (KR) 10-2023-0068696
Jul. 21, 2023 (KR) 10-2023-0095160

(51) Int. Cl. B26B 21/52; B26B 21/22

(52) U.S. Cl. CPC B26B 21/521; B26B 21/225

(57) ABSTRACT

A razor handle may include a first arm and a second arm which are detachably coupled to a razor cartridge including at least one blade and a connector. The first arm and the second arm may be spaced apart in a longitudinal direction and become coupled to the connector while moving away from each other and decoupled from the connector while approaching each other. The razor handle may also include a restoring force-providing part that provides a restoring force against pivoting of the razor cartridge. The restoring force-providing part may provide an ejection load to the razor cartridge in a state that the razor cartridge is coupled to the razor handle in a resting state.

### CROSS-REFERENCE TO RELATED APPLICATIONS

This is a continuation application of International Application No. PCT/KR2024/003979 filed on Mar. 28, 2024, which claims the benefit of Korean Patent Application No. 10-2023-0040806 filed on Mar. 28, 2023, Korean Patent Application No. 10-2023-0068696 filed on May 26, 2023 and Korean Patent Application No. 10-2023-0095160filed on Jul. 21, 2023, the contents of which are all hereby incorporated by reference herein in their entirety.

### BACKGROUND

### Technical Field

The disclosure relates to a razor assembly, and more specifically to a razor assembly including a razor cartridge and a razor handle.

### Description of Related Technology

In general, a razor refers to a product for cutting body hair such as fuzz and beard on a face or body, and includes a razor handle for gripping, and a razor cartridge with a razor blade that comes into contact with skin to shave.

### SUMMARY

One aspect is a razor assembly, in which the exposure of a coupling portion provided in a razor handle to be coupled to a razor cartridge is minimized.

Another aspect is a razor assembly, in which a razor handle and a razor cartridge are easily and accurately coupled, and a user can easily recognize a coupling direction of the razor handle to the razor cartridge.

Another aspect is a razor assembly, in which a razor cartridge is detached from a razor handle with less force, and a user can anticipate a point in time when the razor cartridge will be detached, thereby ejecting the razor cartridge to be ejected at an appropriate distance that is neither too far nor too close.

The aspects of the disclosure are not limited to those described herein, and other aspects not mentioned herein may become apparent to those skilled in the art from the following description.

Another aspect is a razor handle, to which a razor cartridge including at least one blade formed with a cutting edge, accommodating the blade in a longitudinal direction, and provided with a connector on one side thereof is detachably coupled, that includes: first and second arms spaced apart from each other in the longitudinal direction, coupled to the connector as moving away from each other, and detached from the connector as moving closer to each other; and a restoring force providing portion providing a restoring force against pivoting of the razor cartridge, wherein the restoring force providing portion provides an ejection load to the razor cartridge in a state that the razor cartridge is coupled to the razor handle in a resting state, and the razor cartridge is ejected from the razor handle based on the ejection load provided to the razor cartridge by the restoring force providing portion as the first arm and the second arm are moving closer to each other and detached from the connector.

Another aspect is a razor assembly including a razor cartridge, and a razor handle to which the razor cartridge is detachably coupled, wherein the razor cartridge includes a plurality of blades formed with cutting edges, and a blade housing accommodating the plurality of blades in a longitudinal direction, and provided with a connector on one side thereof, and the razor handle includes first and second arms spaced apart from each other in the longitudinal direction, coupled to the connector as moving away from each other, and detached from the connector as moving closer to each other; and a restoring force providing portion providing a restoring force against pivoting of the razor cartridge, wherein the restoring force providing portion provides an ejection load to the razor cartridge in a state that the razor cartridge is coupled to the razor handle in a resting state, and the razor cartridge is ejected from the razor handle based on the ejection load provided to the razor cartridge by the restoring force providing portion as the first arm and the second arm are moving closer to each other and detached from the connector.

Other details of the disclosure are included in the detailed description and the accompanying drawings.

According to the embodiments of the disclosure, the effects are at least as follows.

The coupling portion provided in the razor handle and coupled to the connector of the razor cartridge is not exposed to the outside.

Therefore, the coupling portion is protected from external impact, thereby extending the lifespan of the razor handle.

Further, the razor handle and the razor cartridge are easily and accurately coupled.

In addition, a user can easily recognize the coupling direction of the razor handle to the razor cartridge.

The effects of the disclosure are not limited to those described above, and various other effects are included in the foregoing description.

### BRIEF DESCRIPTION OF THE DRAWINGS

FIG. 1 is a perspective view of a razor assembly according to an embodiment of the disclosure.

FIG. 2 is a plane view of a razor cartridge according to an embodiment of the disclosure.

FIG. 3 is a bottom view of a razor cartridge according to an embodiment of the disclosure.

FIG. 4 is a perspective view showing the bottom of a razor cartridge according to an embodiment of the disclosure.

FIG. 5 is an exploded perspective view of a handle head according to an embodiment of the disclosure, viewed from above.

FIG. 6 is an exploded perspective view of a handle head according to an embodiment of the disclosure, viewed from below.

FIG. 7 is a view showing a position relationship among a first arm, a second arm and a pusher in a neutral state.

FIG. 8 is a view showing a position relationship among a first arm, a second arm and a pusher in a coupling process.

FIG. 9 is a view showing a position relationship among a first arm, a second arm and a pusher in a detachment process.

FIG. 10 is a plan view showing a state immediately before a handle head is coupled to a razor cartridge according to an embodiment of the disclosure.

FIG. 11 is a bottom view showing the handle head in the state of FIG. 10.

FIG. 12 is a plan view showing a state that a handle head is coupled to a razor cartridge according to an embodiment of the disclosure.

FIG. 13 is a bottom view showing the handle head in the state of FIG. 12.

FIG. 14 is a perspective view showing a portion of a razor assembly from which the plunger is omitted from the state of FIG. 12.

FIG. 15 is a view for comparison between a detached state and a coupled state with respect to a plunger according to an embodiment.

FIG. 16 is a view showing that a razor cartridge is ejected from a razor assembly according to an embodiment of the disclosure.

FIG. 17 is a view for comparison between an ejecting direction of a razor cartridge and a sliding direction of a plunger in a razor assembly according to an embodiment of the disclosure.

FIG. 18 is a view for describing the position of a plunger, which is varied depending on a pivot angle of a razor cartridge, in a razor assembly according to an embodiment of the disclosure.

FIG. 19 is a view for describing the pivot center, center of gravity, and support point of a razor cartridge in a razor assembly according to an embodiment of the disclosure.

FIG. 20 is a view for comparison between a detached state and a coupled state of another embodiment of a plunger according to an embodiment of the disclosure.

### DETAILED DESCRIPTION

To make the razor cartridge come into close contact with a user's skin along the curvy contours of the skin, the razor cartridge is pivotally coupled to the razor handle.

The razor handle is formed with a coupling portion for coupling with the razor cartridge, and the coupling portion generally has a structure in which the razor cartridge is pivotally coupled to the razor handle.

When the razor handle is detached from the razor cartridge, the coupling portion is exposed to the outside. If an external impact is applied to the coupling portion while the coupling portion is exposed to the outside, the coupling portion often becomes deformed or damaged, thereby making it difficult to normally couple with the razor cartridge.

In the process of coupling the razor handle and the razor cartridge, the coupling portion and the razor cartridge are often improperly coupled, or it is often inconvenient for a user to couple the razor handle and the razor cartridge due to poor recognition of a coupling direction of the coupling portion with respect to the razor cartridge.

Further, when the razor handle and the razor cartridge are detached, it is unpredictable at what point in time the razor cartridge will be released from the razor handle, and the razor cartridge may be ejected excessively far from the razor handle.

The advantages and characteristics of the disclosure and a method for achieving the advantages and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, in describing components according to an embodiment of the disclosure, terms such as first, second, i), ii), a), and b) may be used. These terms are merely for distinguishing one component from other components, but not limit the substances, order, or sequence of the components. Throughout this specification, when a part “includes” or “comprises” a component, this means that the part further includes other components rather than excluding other components unless explicitly stated otherwise.

Below, a razor assembly according to embodiments of the disclosure will be described with reference to the accompanying drawings.

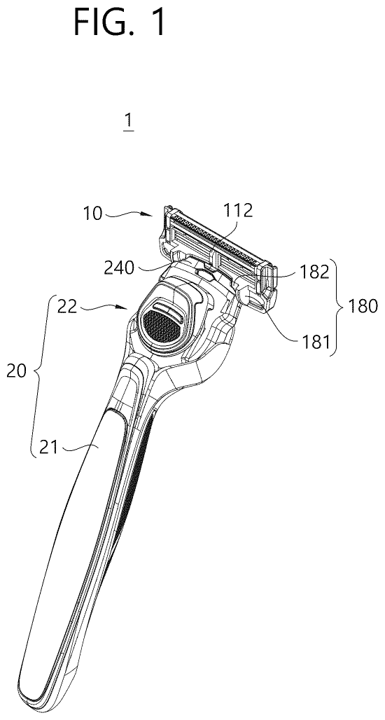

FIG. 1 is a perspective view of a razor assembly 1 according to an embodiment of the disclosure.

Referring to FIG. 1, the razor assembly 1 according to an embodiment includes a razor cartridge 10, and a razor handle 20 to which the razor cartridge 10 is pivotally coupled.

The razor handle 20 includes a handle body 21 and a handle head 22.

The handle body 21 refers to a portion to be gripped by a user.

The handle head 22 is provided at a first end of the handle body 21, is detachably coupled to the razor cartridge 10, and pivotally supports the coupled razor cartridge 10.

The handle head 22 may be detachably coupled to a connector 180 formed in the razor cartridge 10, and pivotably support the razor cartridge 10 within a predetermined angular range about a fixed axis or an axis moving within a predetermined range. For example, the razor cartridge 10 may be pivotably supported within an angular range less than or equal to 90 degrees, preferably less than or equal to 50 degrees, more preferably less than or equal to 45 degrees from a resting position (i.e., a position where the razor cartridge 10 receives no external force while being coupled to the razor handle 20) with respect to the razor handle 20. Regarding the handle head 22, details will be described later.

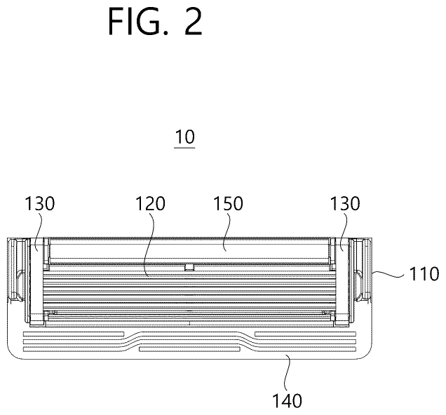

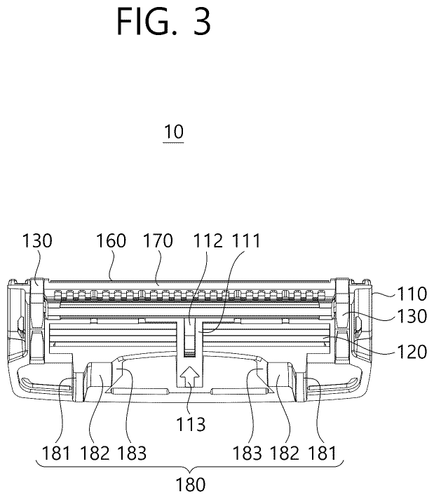

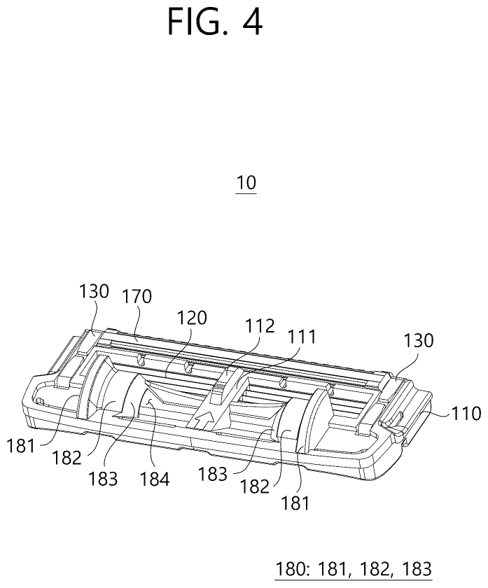

FIG. 2 is a plane view of the razor cartridge 10 according to an embodiment of the disclosure, FIG. 3 is a bottom view of the razor cartridge 10 according to an embodiment of the disclosure, and FIG. 4 is a perspective view showing the bottom of the razor cartridge 10 according to an embodiment of the disclosure.

Referring to FIG. 2, the razor cartridge 10 may include all or some of a blade housing 110, a plurality of blades 120, a clip 130, a guard 140, and a cap 150.

The blade housing 110 may accommodate each blade 120 in a longitudinal direction, and the blades 120 may be arranged in a row in a transverse direction. With respect to FIG. 2, the longitudinal direction refers to a horizontal direction, and the transverse direction refers to a vertical direction. FIG. 2 illustrates an example in which the razor cartridge 10 includes five blades 120, but the number of blades 120 may vary depending on embodiments.

The upper surface of the blade housing 110 to be described below refers to a surface that comes into contact with or faces a user's skin during a shaving process, and may be a surface toward which the cutting edge of each blade 120 faces. FIG. 2 illustrates the upper surface of the blade housing 110.

Further, the lower surface of the blade housing 110 refers to a surface located opposite the upper surface, and FIG. 3 illustrates the lower surface of the blade housing 110.

Further, the front of the blade housing 110 may be a direction (shaving direction) in which the blade housing 110 moves relative to a user's skin during the shaving process. For example, with reference to FIG. 2, the front of the blade housing 110 may refer to a direction from the blade 120 toward the guard 140.

Further, the rear of the blade housing 110 may be a direction opposite to the foregoing front, and, with respect to FIG. 2, the rear of the blade housing 110 may refer to a direction from the blade 120 toward the cap 150.

The clip 130 refers to a component to prevent the plurality of blades 120 from being disengaged with the blade housing 110, and may be coupled to the blade housing 110 in various ways according to embodiments. Further, instead of the clip 130, an additional (e.g., a cover member coupled to the upper surface of the blade housing 110) may be used to prevent the detachment of the plurality of blades 120 from the blade housing 110.

The guard 140 may be provided on the front upper surface of the blade housing 110.

The guard 140 comes into close contact with a user's skin during the shaving process and pulls the skin to enhance a shaving effect of the blade 120. To pull the user's skin more effectively, the guard 140 may include an embossed or engraved pattern on the upper surface thereof, and the upper surface of the guard 140 may be formed of a material such as rubber or silicone.

The cap 150 may be provided on the rear upper surface of the blade housing 110.

The cap 150 may include a lubricating band exposed to the upper surface of the blade housing 110. The lubricating band includes a lubricating material and applies the lubricating material to a skin surface that the blade 120 has passed over during the shaving process. The lubricating material may include ingredients for protecting the skin after shaving.

Referring to FIGS. 3 and 4, the blade housing 110 may include a cam support portion 111 on the lower surface thereof, and a cam 112 protruding from the cam support portion 111. In the state that the razor cartridge 10 and the razor handle 20 are coupled, the cam 112 may be in contact with a plunger 240 (to be described later) to restrict a pivot motion of the razor cartridge 10. The cam support portion 111 may be provided at a central portion on the lower surface of the blade housing 110 and support a base portion of the plurality of blades 120. The cam support portion 111 may be formed with a mark 113 (e.g., an arrow mark) for indicating a coupling direction of the handle head 22 of the razor handle 20.

The razor cartridge 10 may include a connector 180. The connector 180 refers to a component to detachably couple with the handle head 22 of the razor handle 20. The connector 180 may be coupled to the blade housing 110 or formed integrally with the blade housing 110 on the lower surface of the blade housing 110. Alternatively, the connector 180 may be provided in a fixed configuration in the blade housing 110.

The connector 180 may be positioned not to overlap with the blades 120 so that shaving residues (e.g., shaving cream, cut hair, etc.) can be effectively discharged along with washing water through a space between the plurality of blades 120.

The connector 180 may include a pair of guide posts 181, a pair of plunger opposite ends 182, and a pair of guide surfaces 183.

The pair of guide posts 181 may be formed to protrude from the blade housing 110 while being spaced apart from each other in the longitudinal direction. The space between the pair of guide posts 181 forms a space for the plunger 240 of the razor handle 20 (to be described later) to enter. In order for the plunger 240 to smoothly enter, a first side surface of each guide post 181 (i.e., a surface facing the other guide post 181) may form an inclined surface so that the space between the pair of guide posts 181 can become narrower gradually toward the cam 112.

The pair of plunger opposite ends 182 may be formed to protrude from the blade housing 110 while being longitudinally spaced apart from each other between the pair of guide posts 181. The plunger opposite end 182 may be formed to have a height difference from the guide post 181 so that the guide post 181 can protrude further from the blade housing 110 than the plunger opposite end 182. In the state that the razor cartridge 10 and the razor handle 20 are coupled, the plunger opposite end 182 may be adjacent to the plunger 240 (to be described later), or may support the plunger 240.

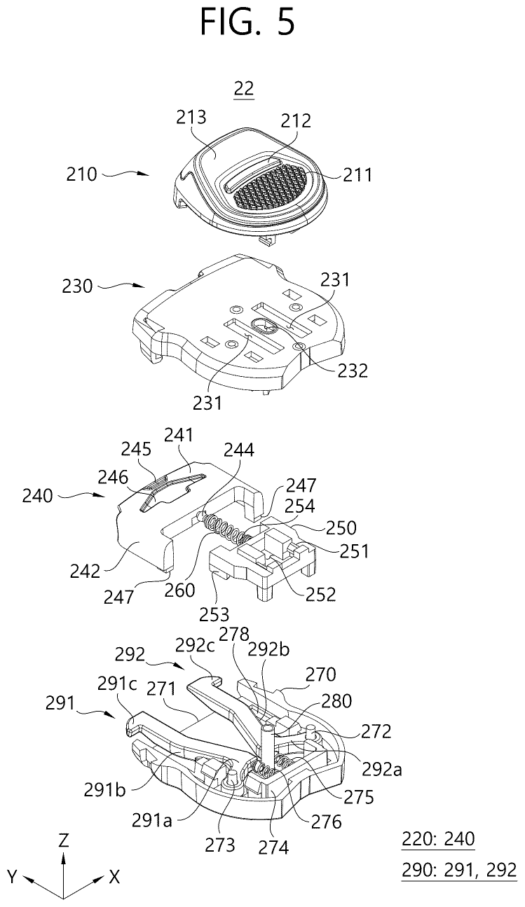

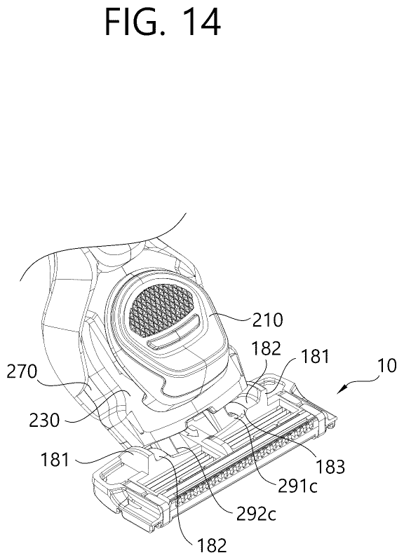

Referring to FIGS. 3 and 4, the pair of guide surfaces 183 form an inclined surface from the plunger opposite ends 182, respectively, so that a space between the pair of guide surfaces 183 can become narrower gradually toward the cam 112. An accommodating space 184 (see FIG. 4) is formed between each of the guide surfaces 183 and the blade housing 110 to accommodate a first end portion 291c (see FIG. 5) and a second end portion 292c (see FIG. 5) of a coupling portion 290 (to be described later). The pair of guide surfaces 183 guides the first end portion 291c and the second end portion 292c of the coupling portion 290 (to be described later) to move toward each other when they enter between the pair of guide surfaces 183. When the first end portion 291c and the second end portion 292c have passed the pair of guide surfaces 183, they move away from each other again and enter the accommodating space 184, thereby completing the coupling between the razor cartridge 10 and the razor handle 20 (see FIG. 14).

A pair of accommodating spaces 184 may accommodate the first end portion 291c and the second end portion 292c, thereby forming a pivot axis of the razor cartridge 10 with respect to the razor handle 20. According to an embodiment, the pair of accommodating spaces 184 are positioned adjacent to the upper surface of the blade housing 110, and thus the pivot axis of the razor cartridge 10 is formed close to a shaving plane where shaving is actually performed, thereby achieving a close shave.

Regarding the coupling, detachment, etc. between the connector 180 and the coupling portion 290, more detailed descriptions will be made later.

The razor cartridge 10 may additionally include a trimming blade 160 and a trimming guard 170.

The trimming blade 160 is accommodated between the trimming guard 170 and the blade housing 110 so that the cutting edge thereof can be exposed toward the rear of the razor cartridge 10. The trimming blade 160 may be used to cut hair in a relatively narrow region, such as sideburns, a mustache, etc. The trimming guard 170 may be formed with a plurality of combs arranged side by side in the longitudinal direction to align the hair before being cut by the trimming blade 160.

Below, the handle head 22 of the razor handle 20 will be described.

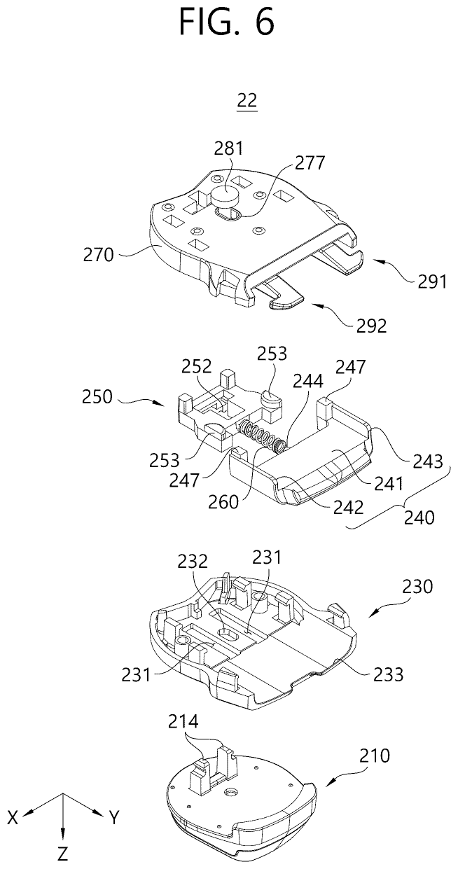

FIG. 5 is an exploded perspective view of the handle head 22 according to an embodiment of the disclosure, viewed from above, and FIG. 6 is an exploded perspective view of the handle head 22 according to an embodiment of the disclosure, viewed from below.

Referring to FIGS. 5 and 6, the handle head 22 according to an embodiment of the disclosure may include an operating portion 210, a restoring force providing portion 220, and the coupling portion 290.

The operating portion 210 is configured to operate the coupling portion 290 by moving a pusher 250, which will be described later. A user may operate the operating portion 210 in the state that the razor cartridge 10 and the razor handle 20 are coupled, thereby detaching the razor cartridge 10 and the razor handle 20. In this regard, details will be described later.

Referring to FIG. 5, the operating portion 210 is located in the upper portion of the handle head 22 (see FIG. 1), and has an upper surface formed with, but not limited to, a friction surface 211 for increasing friction with a user's finger, a stepped portion 212 for preventing the user's finger from slipping, and an upward inclined surface 213 for supporting the user's finger. The friction surface 211, the stepped portion 212 and the inclined surface 213 allow a user to more easily move the operating portion 210 when s/he pushes the operating portion 210 with a finger (or a thumb) in a first direction. Here, the first direction may refer to a direction from the handle head 22 toward the razor cartridge 10. Referring to FIGS. 5 and 6, the first direction is a positive Y-axis direction. An X-axis refers to a longitudinal direction perpendicular to the Y-axis on a horizontal plane, a positive Z-axis direction refers to an upward direction, and a negative Z-axis direction refers to a downward direction.

Referring to FIG. 6, the operating portion 210 has a lower surface provided with a pusher coupling portion 214 extending downwards (in the negative Z-axis direction). The pusher coupling portion 214 couples with the pusher 250 penetrating a plunger upper housing 230 (to be described later) and accommodated in the plunger housings 230 and 270. Accordingly, the pusher 250 accommodated in the plunger housings 230 and 270 moves integrally with the operating portion 210 located outside the plunger housings 230 and 270.

The restoring force providing portion 220 is configured to provide a restoring force to the razor cartridge 10, which is pivotable about the razor handle 20 within a certain angular range. Referring to FIGS. 5 and 6, the handle head 22 according to an embodiment of the disclosure includes the plunger 240 as the restoring force providing portion 220, but is not limited thereto, and the restoring force providing portion 220 may include a cantilever structure and/or a rubber member having an elastic force to provide the restoring force to the razor cartridge 10. Hereinafter, for convenience of description, an example that the restoring force providing portion 220 includes the plunger 240 will be described.

The plunger housings 230 and 270 include the plunger upper housing 230 and a plunger lower housing 270. The plunger upper housing 230 and the plunger lower housing 270 form a space in which the plunger 240, the pusher 250 and the coupling portion 290 are accommodated.

Referring to FIG. 5, the plunger upper housing 230 may have a pusher coupling slot 231 and a first pin through slot 232 formed therethrough. The pusher coupling slot 231 and the first pin through slot 232 may be formed long along the first direction.

The pusher coupling portion 214 of the operating portion 210 passes through the pusher coupling slot 231, and the first end of a pin 280 passes through the first pin through slot 232 and is coupled to the operating portion 210. The pusher coupling portion 214 is movable in the first direction along the pusher coupling slot 231. Accordingly, the operating portion 210 is movable in the first direction with respect to the plunger upper housing 230.

Referring to FIG. 6, a distal end portion 233 of the plunger upper housing 230 may be open in the first direction such that the plunger 240 and the coupling portion 290 are at least partially exposed or appear or disappear from the plunger upper housing 230.

Referring back to FIG. 5, a distal end portion 271 of the plunger lower housing 270 may also be open in the first direction such that the plunger 240 and the coupling portion 290 are at least partially exposed or appear or disappear from the plunger lower housing 270.

The plunger lower housing 270 may be internally formed with a first arm rotation pin 273 and a second arm rotation pin 272, on which a first arm 291 and a second arm 292 of the coupling portion 290 are rotatably installed.

Further, the plunger lower housing 270 may be internally formed with a support base 274 to determine a retreat limit of the pusher 250 in the first direction. The support base 274 may be provided between the first arm rotation pin 273 and the second arm rotation pin 272, without restricting the intended rotation of the first arm 291 and the second arm 292. Further, the first arm 291 may be elastically supported by an elastic member 276 provided between the support base 274 and the first arm 291, and the second arm 292 may be elastically supported by an elastic member 275 provided between the support base 274 and the second arm 292. In other words, the first arm 291 and the second arm 292 may be elastically supported by the support base 274. The first arm 291 and the second arm 292 may be elastically supported in a direction in which the elastic members 275 and 276 is stretched, respectively. In other words, the elastic members 275 and 276 may provide a restoring force in a direction in which the first end portion 291c and the second end portion 292c exposed to the outside of the plunger housings 230 and 270 move away from each other.

Referring to FIGS. 5 and 6, the plunger lower housing 270 may have the second pin through slot 277 formed therethrough. The second pin through slot 277 may be formed long along the first direction.

The second end of the pin 280 may be exposed to the lower portion of the plunger lower housing 270 (in the negative Z-axis direction) through the second pin through slot 277, and the second end of the pin 280 is provided with a flange 281 having a diameter larger than the width of the second pin through slot 277 to prevent the second end of the pin 280 from entering the plunger housings 230 and 270.

Referring to FIG. 5, the pusher 250 may include an operating-portion coupling portion 251 coupled to the pusher coupling portion 214 of the operating portion 210. FIGS. 5 and 6 illustrate an example that the pusher coupling portion 214 and the operating-portion coupling portion 251 have a hook-coupled structure, but the pusher coupling portion 214 and the operating-portion coupling portion 251 may be modified to have various coupling structures.

Further, the pusher 250 may be formed with a third pin through slot 252 through which the central portion of the pin 280 passes.

Referring to FIG. 5 and FIG. 6, a pair of driving protrusions 253 spaced apart in the longitudinal direction are formed on the lower surface of the pusher 250. The pair of driving protrusions 253 are positioned to be in contact with a first driving surface 291b of the first arm 291 and a second driving surface 292b of the second arm 292, respectively. As the pusher 250 moves forward/backward, the driving protrusion 253 interacts with the first driving surface 291b and the second driving surface 292b so that the first arm 291 can rotate around the first arm rotation pin 273, and the second arm 292 can rotate around the second arm rotation pin 272. In this regard, detailed descriptions will be made later.

The pusher 250 may be formed with a first elastic member mounting portion 254 at a distal end portion thereof, on which the first end of an elastic member 260 for elastically supporting the pusher 250 and the plunger 240 is installed.

Referring to FIGS. 5 and 6, the plunger 240 may include an upper cover 241, a first lateral wall 243 extending downwardly from the first side of the upper cover 241 and a second lateral wall 242 extending downwardly from the second side of the upper cover 241.

The plunger 240 may be provided to slide and move along the first direction within the plunger housings 230 and 270. In the state that the plunger 240 is elastically supported by the elastic member 260 and is positioned at a forward limit point in the first direction, the upper cover 241 may be positioned to cover all or a portion of the first end portion 291c of the first arm 291 and the second end portion 292c of the second arm 292. In the state that the elastic member 260 elastically supporting the plunger 240 is compressed and the plunger 240 is positioned at a retreat limit point in the first direction, the upper cover 241 may be positioned to expose the first end portion 291c of the first arm 291 and the second end portion 292c of the second arm 292 to the outside.

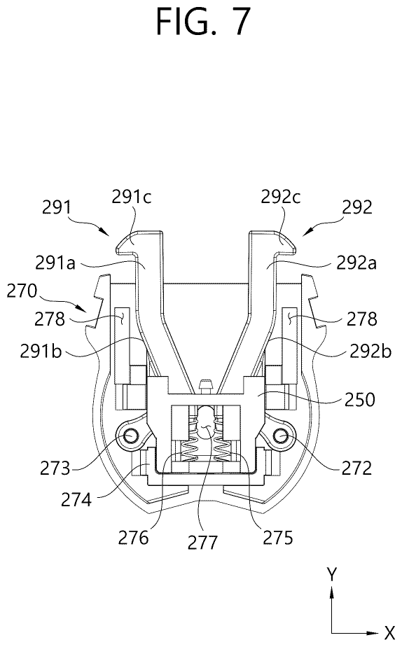

The lower housing 270 may include a guide groove 278 (see FIGS. 5 and 7) formed along the sliding direction (the first direction) of the plunger 240, and the plunger 240 may include a slider 247 accommodated in the guide groove 278. When the plunger 240 slides within the plunger housings 230 and 270 along the first direction, the slider 247 may move along the guide groove 278 while being accommodated in the guide groove 278. Due to the interaction between the slider 247 and the guide groove 278, the plunger 240 may slide along the first direction. In this case, the plunger 240 may not move forward beyond the forward limit point.

The upper cover 241 may include a cam contact portion 245 formed at a distal end portion thereof and comes into contact with the cam 112 of the razor cartridge 10. The cam contact portion 245 may be shaped to define the pivot motion of the razor cartridge 10 relative to the razor handle 20 by interacting with the shape of the cam 112. The cam contact portion 245 may be engraved and/or embossed relative to the upper cover 241.

The upper cover 241 may include a mark 246 (e.g., an arrow mark) formed to indicate the coupling direction of the handle head 22 to the razor cartridge 10. The mark 246 allows a user to easily recognize the coupling direction of the razor handle 20 to the razor cartridge 10. The mark 246 may be formed at a position to be aligned with the mark 113 formed in the razor cartridge 10 during the coupling process between the razor cartridge 10 and the razor handle 20 in the coupling direction, thereby allowing a user to more clearly recognize the coupling direction of the razor handle 20 to the razor cartridge 10.

The plunger 240 may include a second elastic member mounting portion 244 formed at the rear end thereof, on which the second end of the elastic member 260 for elastically supporting the pusher 250 and the plunger 240 is installed.

Referring to FIG. 5, the coupling portion 290 may include the first arm 291 and the second arm 292 which are spaced from each other in the longitudinal direction.

In the embodiment shown in FIG. 5, the coupling portion 290 includes the first arm 291 and the second arm 292, but the disclosure is not limited thereto. The coupling portion 290 may employ various configurations to detachably couple with the razor cartridge 10. For example, besides the pair of arms 291 and 292, the coupling portion 290 may use a latch coupling method, a hook coupling method, a snap-fit coupling method, a boss coupling method, a magnetic-based coupling method, etc. to detachably couple with the razor cartridge 10. However, for convenience of description, the following description will be made based on an example that the coupling portion 290 includes the first arm 291 and the second arm 292.

Further, as described above, the restoring force providing portion 220 may be included in the razor handle 20, but the disclosure is not limited thereto. According to an embodiment, the restoring force providing portion 220 may be included in the razor cartridge 10.

In this case, the restoring force providing portion 220 may be positioned on the connector 180, and the connector 180 may be pivotably connected to the blade housing 110. Further, as described above, the restoring force providing portion 220 may include a cantilever structure and/or a rubber member providing an elastic force besides the elastically supported plunger 240, thereby providing the restoring force to the razor cartridge 10. When the restoring force providing portion 220 is provided in the razor cartridge 10, the restoring force providing portion 220 may cover at least a part of the coupling portion 290 in the process of coupling or detaching the razor cartridge 10 and the razor handle 20. In the state that the razor cartridge 10 and the razor handle 20 are coupled, the restoring force providing portion 220 may cover at least a part of the coupling portion 290.

The first arm 291 may include a first driving arm 291a, the first driving surface 291b, and the first end portion 291c.

The first driving arm 291a has a first side rotatably installed on the first arm rotation pin 273. The first driving arm 291a extends toward the open distal end portions of the plunger housings 230 and 270.

The first driving surface 291b may form at least a portion of an outer surface of the first driving arm 291a, and may be formed to form an outward slope in the first direction, but is not necessarily limited thereto.

The first end portion 291c is formed on a second side of the first driving arm 291a, which is exposed to the outside of the plunger housings 230 and 270. The first end portion 291c may be formed to protrude outwardly from the first driving arm 291a. The front side of the first end portion 291c may be formed to be inclined toward the negative X-axis direction, and the rear side of the first end portion 291c may form the stepped portion approximately perpendicular to the first driving arm 291a, but is not necessarily limited thereto. For example, when the first end portion 291c is detachably coupled to the razor cartridge 10 by a shell-bearing coupling method, the first end portion 291c may include a shell-bearing.

In the case where the front side of the first end portion 291c is formed to be inclined toward the negative X-axis direction, when the razor cartridge 10 and the razor handle 20 are coupled, the first end portion 291c smoothly moves along the guide post 181, the plunger opposite end 182 and the guide surface 183 of the connector 180, and the first driving arm 291a naturally rotates around the first arm rotation pin 273, thereby inducing natural coupling between the razor cartridge 10 and the razor handle 20. However, the front side shape of the first end portion 291c may be varied depending on the structure, etc. of the connector 180, and may be configured without the inclined surface toward the negative X-axis direction.

When the first end portion 291c includes the stepped portion formed on the rear side thereof, which is approximately perpendicular to the first driving arm 291a, the first end portion 291c is prevented from being disengaged in the negative Y-axis direction while being inserted in the accommodating space 184, so that the razor cartridge 10 and the razor handle 20 can be maintained in the coupled state. The rear side of the first end portion 291c may be modified to have various shapes so as not to form the stepped portion that is approximately perpendicular to the first driving arm 291a, and to prevent the first end portion 291c from being disengaged in the negative Y-axis direction while the first end portion 291c is inserted in the accommodating space 184.

The second arm 292 may include a second driving arm 292a, the second driving surface 292b, and the second end portion 292c.

The second driving arm 292a has a first side rotatably installed on the second arm rotation pin 272. The second driving arm 292a extends toward the open distal end portions of the plunger housings 230 and 270.

The second driving surface 292b may form at least a portion of an outer surface of the second driving arm 292a, and may be formed to form an outward slope in the first direction, but is not necessarily limited thereto.

The second end portion 292c is formed on a second side of the second driving arm 292a, which is exposed to the outside of the plunger housings 230 and 270. The second end portion 292c may be formed to protrude outwardly from the second driving arm 292a. The front side of the second end portion 292c may be formed to be inclined rearwards, and the rear side of the second end portion 292c may form the stepped portion approximately perpendicular to the second driving arm 292a, but is not necessarily limited thereto. For example, when the second end portion 292c is detachably coupled to the razor cartridge 10 by a shell-bearing coupling method, the second end portion 292c may include a shell-bearing.

In the case where the front side of the second end portion 292c is formed to be inclined toward the positive X-axis direction, when the razor cartridge 10 and the razor handle 20 are coupled, the second end portion 292c smoothly moves along the guide post 181, the plunger opposite end 182 and the guide surface 183 of the connector 180, and the second driving arm 292a naturally rotates around the second arm rotation pin 272, thereby inducing natural coupling between the razor cartridge 10 and the razor handle 20. However, the front side shape of the second end portion 292c may be varied depending on the structure, etc. of the connector 180, and may be configured without the inclined surface toward the positive X-axis direction.

When the second end portion 292c includes the stepped portion formed on the rear side thereof, which is approximately perpendicular to the second driving arm 292a, the second end portion 292c is prevented from being disengaged in the negative Y-axis direction while being inserted in the accommodating space 184, so that the razor cartridge 10 and the razor handle 20 are maintained in the coupled state. The rear side of the second end portion 292c may be modified to have various shapes so as not to form the stepped portion that is approximately perpendicular to the second driving arm 292a, and to prevent the second end portion 292c from being disengaged in the negative Y-axis direction while the second end portion 292c is inserted in the accommodating space 184.

FIG. 7 is a view showing a position relationship among the first arm 291, the second arm 292, and the pusher 250 in a neutral state.

The neutral state in FIG. 7 refers to a state in which no other external force is applied to the pusher 250, the first arm 291 and the second arm 292. Therefore, in the neutral state, the pusher 250 may be located at or adjacent to the retreat limit point, and the first arm 291 and the second arm 292 may be spread outward as much as possible with respect to each other.

The detached state where the razor handle 20 and the razor cartridge 10 are completely detached and/or the coupled state where the razor handle 20 and the razor cartridge 10 are completely coupled may be the neutral state.

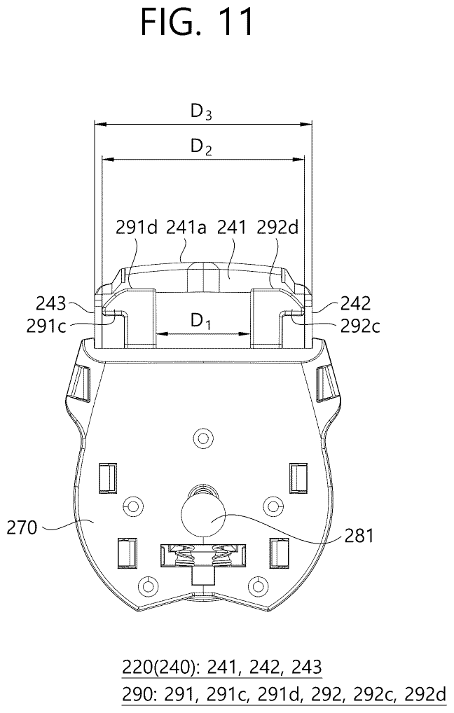

Meanwhile, even in the same neutral state, the position of the plunger 240 may be varied depending on whether it is in the detached state or the coupled state. For example, in the detached state, the plunger 240 may be positioned forward so that the first end portion 291c and the second end portion 292c can be covered with the plunger 240 (see FIG. 11), and in the coupled state, the position of the plunger 240 may retreat so that the first end portion 291c and the second end portion 292c can be exposed to the outside of the plunger 240.

On the other hand, the detached state and/or the coupled state may not be the neutral state. For example, when the first end portion 291c and the second end portion 292c in the detached state are supported on the first lateral wall 243 and the second lateral wall 242 of the plunger 240, respectively, a distance between the first end portion 291c and the second end portion 292c in the detached state may be shorter than a distance between the first end portion 291c and the second end portion 292c in the neutral state. Alternatively, in the coupled state, the first driving arm 291a, the first end portion 291c, the second driving arm 292a and/or the second end portion 292c may be supported on the connector 180, for example, on the guide surface 183, such that a distance between the first end portion 291c and the second end portion 292c in the coupled state may be shorter than the distance between the first end portion 291c and the second end portion 292c in the neutral state.

However, when the first end portion 291c and the second end portion 292c in the detached state are not supported by the first lateral wall 243 and the second lateral wall 242 of the plunger 240, respectively, but positioned adjacent to the first lateral wall 243 and the second lateral wall 242, the distance between the first end portion 291c and the second end portion 292c may be substantially the same in the detached state and the neutral state, or in the detached state, the neutral state and the coupled state.

Referring to FIG. 7, in the detached state and/or the coupled state, the pusher 250 may be positioned at the retreat limit point or adjacent to the retreat limit point in the first direction. In this case, the driving protrusion 253 of the pusher 250 may be positioned at the innermost point of the first driving surface 291b and the innermost point of the second driving surface 292b. Further, the pusher 250 may be supported on the support base 274.

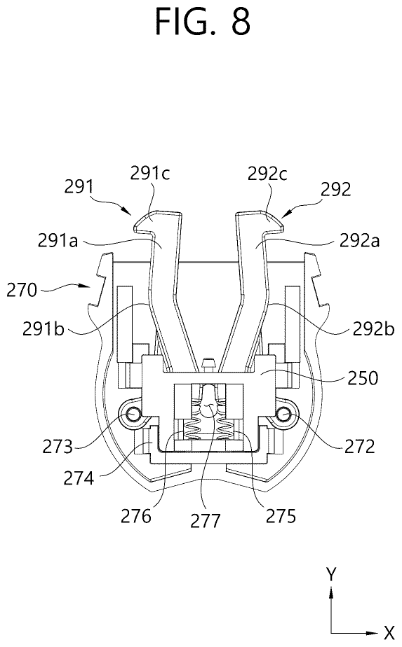

FIG. 8 is a view showing a position relationship among the first arm 291, the second arm 292 and the pusher 250 in a coupling process. In this specification, the coupling process refers to the process in which the razor handle 20 and the razor cartridge 10 are connected, in other words, an intermediate process from the detached state toward the coupled state.

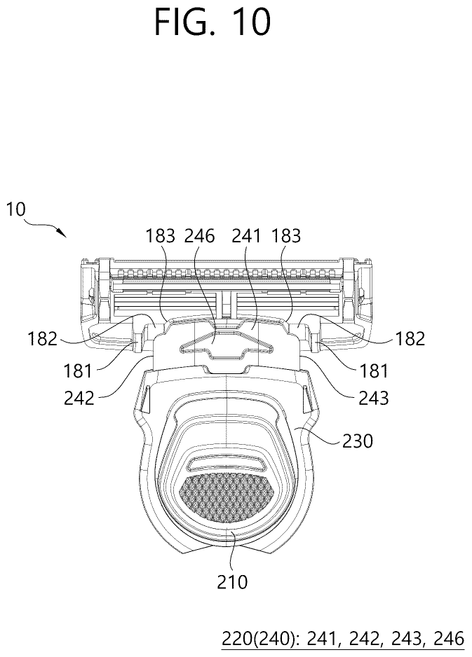

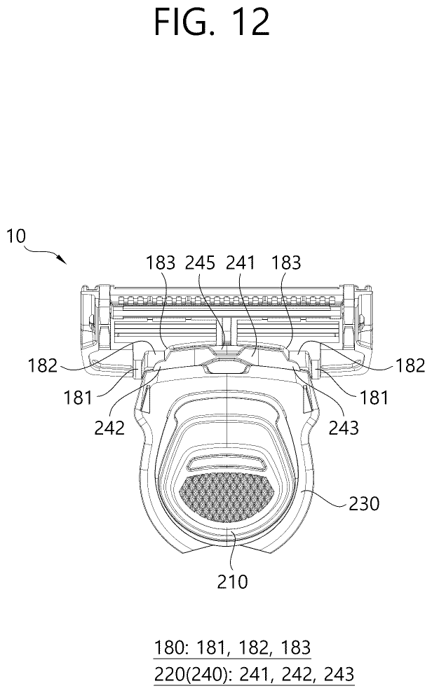

After a distal end portion 241a of the plunger 240 comes into contact with the blade housing 110 as the connector 180 of the razor cartridge 10 and the handle head 22 approach each other, the plunger 240 retreats rearwardly in the first direction toward the inside of the plunger housings 230 and 270 while being supported by the plunger opposite end 182 and/or the guide surface 183 (see FIGS. 10 and 12). The contact between the distal end portion 241a of the plunger 240 and the blade housing 110 may occur before the contact between the distal end portions 291d and 292d of the arms 291 and 292 and the connector 180. In this case, the contact between the distal end portions 291d and 292d of the arms 291 and 292 and the connector 180 may be made after the plunger 240 has retreated a predetermined distance rearwardly in the first direction.

Alternatively, the contact between the distal end portion 241a of the plunger 240 and the blade housing 110 may occur simultaneously with the contact between the distal end portions 291d and 292d of the arms 291 and 292 and the connector 180.

Alternatively, the contact between the distal end portions 291d and 292d of the arms 291 and 292 and the connector 180 may occur before the contact between the distal end portion 241a of the plunger 240 and the blade housing 110.

The lower surface region of the blade housing 110 to be in contact with the plunger 240 may be formed to correspond to at least a portion of the shape of the distal end portion 241a of the plunger 240. In this way, the plunger 240 and the blade housing 110 may be in stable contact with each other, and the coupling positions of the connector 180 and the handle head 22 may be naturally aligned. Further, a user's recognition for the alignment direction of the connector 180 and the handle head 22 may be improved.

For example, the plunger opposite end 182 and/or the guide surface 183 of the connector 180 may be shaped to correspond to the shapes of both sides of the distal end portion 241a of the plunger 240 and the lateral walls 242 and 243 of the plunger 240. Alternatively, the distal end portion 241a of the plunger 240 may be formed convexly so as to make a longitudinal (X-directional) width become narrower in the first direction, and the lower surface region of the blade housing 110 to be in contact with the distal end portion 241a may be formed concavely so as to be aligned with the distal end portion 241a.

As the connector 180 and the handle head 22 approach further each other, the first end portion 291c of the first arm 291 and the second end portion 292c of the second arm 292 pass along the guide surface 183 or pass the plunger opposite end 182 and the guide surface 183 in sequence, and, as shown in FIG. 8, the first arm 291 and the second arm 292 rotate about the first arm rotation pin 273 and the second arm rotation pin 272, respectively, such that the first end portion 291c and the second end portion 292c become closer. The elastic members 275 and 276 provide restoring forces to the first arm 291 and the second arm 292, respectively, in a direction of increasing the distance between the first end portion 291c and the second end portion 292c, so that the first end portion 291c and the second end portion 292c can move while maintaining the contact with the guide surface 183.

When each of the first end portion 291c and the second end portion 292c passes through the guide surface 183, the first end portion 291c and the second end portion 292c move back to the neutral state (the coupled state) illustrated in FIG. 7 while entering the accommodating space 184 by the restoring force provided from the elastic members 275 and 276.

Referring back to FIG. 8, in the process of coupling the razor cartridge 10 and the razor handle 20, the pusher 250 may not move from the neutral state. In other words, a user may complete the coupling between the razor cartridge 10 and the razor handle 20 even though s/he does not close the first arm 291 and the second arm 292 together by manipulating the operating portion 210 in the process of coupling the razor cartridge 10 and the razor handle 20.

The connector 180 includes the guide surface 183, thereby guiding the first end portion 291c of the first arm 291 and the second end portion 292c of the second arm 292 to naturally enter the accommodating space 184 by a user's simple motion of bringing the razor cartridge 10 and the razor handle 20 closer to each other.

Further, the handle head 22 includes the elastic members 275 and 276 that provide the restoring force to the first arm 291 and the second arm 292, thereby inducing the first end portion 291c and the second end portion 292c to naturally enter the accommodating space 184 immediately after passing the guide surface 183 by a user's simple motion of bring the razor cartridge 10 and the razor handle 20 closer to each other.

Further, even with a user's simple motion of bringing the razor cartridge 10 and the razor handle 20 closer to each other, the plunger 240 is supported on the blade housing 110 and retreats toward the inside of the plunger housings 230 and 270, and the first end portion 291c of the first arm 291 and the second end portion 292c of the second arm 292 are automatically exposed from the plunger 240 and coupled to the connector 180. In other words, the first end portion 291c of the first arm 291 and the second end portion 292c of the second arm 292 are covered with the plunger 240 in the detached state so as not to be exposed to the outside, but a user does not need to separately operate the plunger 240 so as to couple the razor cartridge 10 and the razor handle 20.

Accordingly, a user may complete the coupling of the razor cartridge 10 and the razor handle 20 by only bring the razor cartridge 10 and the razor handle 20 closer to each other without manipulating the operating portion 210 or the plunger 240 during the coupling process of the razor cartridge 10 and the razor handle 20.

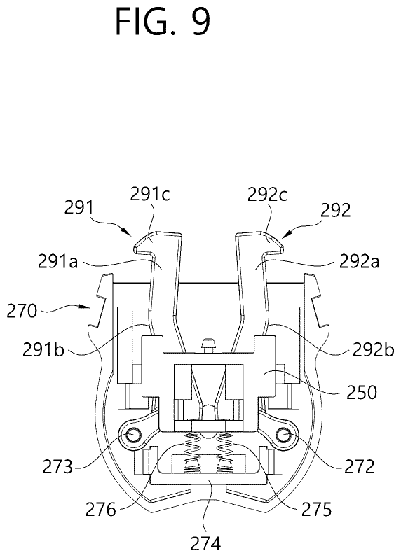

FIG. 9 is a view showing a position relationship among the first arm 291, the second arm 292 and the pusher 250 during the detachment process. In this specification, the detachment process refers to the process in which the razor handle 20 and the razor cartridge 10 are detached, in other words, an intermediate process from the coupled state to the detached state.

To detach the razor cartridge 10 and the razor handle 20, a user may move the operating portion 210 forward in the first direction, thereby causing the pusher 250 to move forward in the first direction.

Referring to FIG. 9, as the pusher 250 moves forward in the first direction, the driving protrusion 253 of the pusher 250 moves along the first driving surface 291b and the second driving surface 292b while moving forward in the first direction. As the driving protrusion 253 moves forward in the first direction, the first arm 291 rotates clockwise about the first arm rotation pin 273, and the second arm 292 rotates counterclockwise about the second arm rotation pin 272, thereby getting the first end portion 291c and the second end portion 292c closer to each other gradually.

Because the pusher 250 moves integrally with the operating portion 210, a user may make the operating portion 210 moves forward in the first direction to bring the first end portion 291c and the second end portion 292c closer to each other. When a user wants to detach the razor cartridge 10 and the razor handle 20, s/he may move the operating portion 210 forward in the first direction to bring the first end portion 291c and the second end portion 292c closer to each other, thereby detaching the first end portion 291c and the second end portion 292c from the connector 180 of the razor cartridge 10.

In the state of FIG. 9, when a user removes the force for moving the operating portion 210 forward in the first direction, the first arm 291 and the second arm 292 return back to the state of FIG. 7 by the restoring force of the elastic members 275 and 276. As the first arm 291 and the second arm 292 return back to the state of FIG. 7, the pusher 250 also retreats and becomes positioned in the state of FIG. 7 by the interaction between the driving protrusion 253 and the first and second driving surfaces 291b and 292b. Along with the retreat of the pusher 250, the operating portion 210 also retreats and becomes positioned at the retreat limit point.

FIG. 10 is a plan view showing a state immediately before the handle head 22 is coupled to the razor cartridge 10 according to an embodiment of the disclosure, and FIG. 11 is a bottom view showing the handle head 22 in the state of FIG. 10.

In FIGS. 10 and 11, the razor cartridge 10 and the handle head 22 are in the state just before being coupled to each other, and thus the plunger 240, the first arm 291 and the second arm 292 are assumed to be in the ‘detached state’ mentioned above with reference to FIG. 7.

Referring to FIGS. 10 and 11, in the state that the handle head 22 is detached from the razor cartridge 10, the first arm 291 and the second arm 292 exposed from the distal end portion 241a of the plunger housings 230 and 270 are not exposed to the outside by the plunger 240. Because the first arm 291 and the second arm 292 are not exposed to the outside, the first arm 291 and the second arm 292 are protected from external impact, thereby extending the lifespan of the razor handle 20 and improving aesthetics in an outer appearance.

Referring to FIG. 11, in the state that the handle head 22 is detached from the razor cartridge 10, the first arm 291 may be supported or in contact with the first lateral wall 243 of the plunger 240, and the second arm 292 may be supported or in contact with the second lateral wall 242 of the plunger 240. Alternatively, in the state that the handle head 22 is detached from the razor cartridge 10, the first arm 291 may be spaced apart from the first lateral wall 243 of the plunger 240, and the second arm 292 may be spaced apart from the second lateral wall 242 of the plunger 240.

Further, referring to FIG. 11, in the state that the handle head 22 is detached from the razor cartridge 10, the distal end portion 291d of the first arm 291 and the distal end portion 292d of the second arm 292 may be positioned reward than the distal end portion 241a of the plunger 240 in the first direction, such that the plunger 240 covers the first arm 291 and the second arm 292 from above. Alternatively, in the state that the handle head 22 is detached from the razor cartridge 10, the distal end portion 291d of the first arm 291 and the distal end portion 292d of the second arm 292 may be located at the same position as the distal end portion 241a of the plunger 240 in the first direction.

Further, in the process of coupling the handle head 22 and the razor cartridge 10, the contact between the distal end portion 241a of the plunger 240 and the blade housing 110 may occur before the contact between the distal end portions 291d and 292d of the arms 291 and 292 and the connector 180. When the contact between the distal end portion 241a of the plunger 240 and the blade housing 110 occurs, natural alignment may be induced at the coupling position between the razor cartridge 10 and the razor handle 20, and a user's recognition for the direction of aligning the razor cartridge 10 and the razor handle 20 may be improved. Further, referring to FIG. 11, in the state that the razor cartridge 10 is detached from the handle head 22, an outer distance D2 between the first end portion 291c and the second end portion 292c may be smaller than a longitudinal width D3 of the plunger 240 so that the plunger 240 can cover the first arm 291 and the second arm 292 from above. Alternatively, in the state that the razor cartridge 10 is detached from the handle head 22, the outer distance D2 between the first end portion 291c and the second end portion 292c may be substantially equal to the longitudinal width D3 of the plunger 240. As examples shown in FIGS. 10 and 11, the restoring force providing portion 220 includes the plunger 240, but the disclosure is not limited thereto. The restoring force providing portion 220 may include a cantilever structure and/or a rubber member providing an elastic force, etc., to provide the restoring force to the razor cartridge 10.

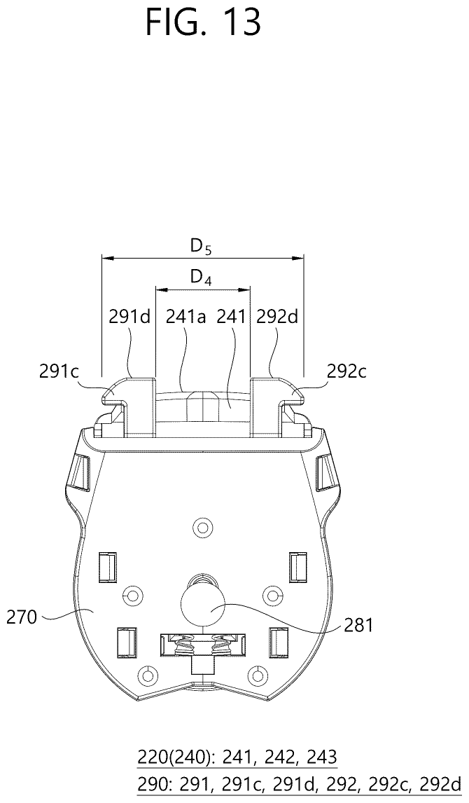

FIG. 12 is a plan view showing the state that the handle head 22 is coupled to the razor cartridge 10 according to an embodiment of the disclosure, FIG. 13 is a bottom view showing the handle head 22 in the state of FIG. 12, and FIG. 14 is a perspective view showing a portion of the razor assembly 1 from which the plunger 240 is omitted from the state of FIG. 12

Referring to FIG. 12, when the handle head 22 is coupled to the razor cartridge 10, the plunger 240 is positioned between the pair of guide posts 181. Further, the first lateral wall 243 and the second lateral wall 242 of the plunger 240 face the pair of plunger opposite ends 182 and 182, respectively. The first lateral wall 243 and the second lateral wall 242 may be positioned adjacent to the plunger opposite end 182 and 182, respectively, or may be supported on the plunger opposite end 182.

Referring to FIGS. 12 to 14, the process of coupling the razor cartridge 10 and the razor handle 20 will be described. The plunger 240 is supported by the connector 180 and retreats toward the inside of the plunger housings 230 and 270. As the plunger 240 retreats, the first arm 291 and the second arm 292 are exposed, and the first end portion 291c and the second end portion 292c come into contact with the pair of guide surfaces 183 and 294, respectively. As the razor cartridge 10 and the razor handle 20 get closer, the first arm 291 and the second arm 292 rotate so that the distance between the first end portion 291c and the second end portion 292c can get closer until the first end portion 291c and the second end portion 292c pass the pair of guide surfaces 183. After the first end portion 291c and the second end portion 292c pass the pair of guide surfaces 183, the first arm 291 and the second arm 292 are rotated so that the first end portion 291c and the second end portion 292c can move away from each other by the restoring force provided from the elastic members 275 and 276, and as illustrated in FIG. 14, each of the first end portion 291c and the second end portion 292c enters the accommodating space 184 (see FIG. 4) between the guide surface 183 and the blade housing 110, thereby completing the coupling between the coupling portion 290 and the connector 180.

In the neutral state, when the first arm 291 and the second arm 292 are supported by or in contact with the first lateral wall 243 and the second lateral wall 242 of the plunger 240, the plunger 240 retreats in the process of coupling the coupling portion 290 and the connector 180, thereby releasing the support or contact state between the first arm 291 and the first lateral wall 243 and the support or contact state between the second arm 292 and the second lateral wall 242. The coupling between the coupling portion 290 and the connector 180 may be performed simultaneously with the release of the support or contact state between the first arm 291 and the first lateral wall 243 and the release of the support or contact state between the second arm 292 and the second lateral wall 242.

Meanwhile, in the neutral state, when the first arm 291 and the second arm 292 are not supported or in contact with the first lateral wall 243 and the second lateral wall 242 of the plunger 240, and the first end portion 291c and the second end portion 292c are spaced apart from the first lateral wall 243 and the second lateral wall 242, the contact between the plunger 240 and the blade housing 110 may occurs first with a time difference from or may occur simultaneously with the contact between the connector 180 and the first and second arms 291 and 292, depending on the relative positions between the distal end portion 241a of the plunger 240 and the first and second end portions 291c and 292c, the lower surface shapes of the blade housing 110 to come into contact with the plunger 240, the shapes of the connector 180, etc. in the process of coupling the coupling portion 290 and the connector 180.

Because the plunger 240 is elastically supported by the elastic member 260 (see FIG. 5) disposed between the plunger 240 and the pusher 250, the plunger 240 maintains the contact with the razor cartridge 10 and provides the restoring force to the razor cartridge 10 while moving forward or backward along the first direction even though the razor cartridge 10 pivots being coupled to the razor handle 20.

Referring to FIG. 13, in the state that the handle head 22 is coupled to the razor cartridge 10, the distal end portion 291d of the first arm 291 and the distal end portion 292d of the second arm 292 may be positioned in front of the distal end portion 241a of the plunger 240 in the first direction.

Referring to FIG. 12, even when the coupling portion 290 is coupled to the connector 180, the first arm 291 and the second arm 292 exposed to the outside of the plunger housings 230 and 270 may be covered with the plunger 240 and not exposed to the outside. For example, when the razor cartridge 10 and the razor handle 20 are coupled, the first arm 291 and the second arm 292 may not be exposed to the outside by the plunger 240 in the state (resting position) that the razor cartridge 10 is supported by the plunger 240 without an external force applied thereto, but the first arm 291 and the second arm 292 may be at least partially not covered by the plunger 240 but exposed to the outside in the state that the razor cartridge 10 is pivoted from the resting state by an external force applied to the razor cartridge 10 and/or the razor handle 20.

At least in the resting position, in the state that the coupling portion 290 is coupled to the connector 180 so as not to be exposed to the outside by the plunger 240, an outer distance D5 between the first end portion 291c and the second end portion 292c may be smaller than or substantially equal to the longitudinal width D3 of the plunger 240.

Further, an inner distance D4 between the first end portion 291c and the second end portion 292c may be smaller than the longitudinal width D3 of the plunger 240, but the disclosure is not limited thereto. According to an embodiment, the inner distance D4 between the first end portion 291c and the second end portion 292c may be substantially equal to the longitudinal width D3 of the plunger 240. In this case, when the coupling portion 290 is coupled to the connector 180, the first arm 291 and the second arm 292 exposed to the outside of the plunger housings 230 and 270 may not be exposed to the outside as covered not only with the plunger 240 but also with a certain region of the connector 180 located at the longitudinal lateral side of the plunger 240.

For example, in the state that the coupling portion 290 is coupled to the connector 180, a ratio of the longitudinal width D3 of the plunger 240 to an outer distance D5 between the first end portion 291c and the second end portion 292c may range from 0.8 to 1.2.

Meanwhile, the inner distance D4 and the outer distance D5 between the first end portion 291c and the second end portion 292c in the state that the coupling portion 290 is coupled to the connector 180 may be substantially the same as the inner distance D1 (see FIG. 11) and the outer distance D2 between the first end portion 291c and the second end portion 292c in the state that the coupling portion 290 is detached from the connector 180.

Alternatively, the inner distance D4 and the outer distance D5 between the first end portion 291c and the second end portion 292c in the state that the coupling portion 290 is coupled to the connector 180 may be smaller than the inner distance D1 (see FIG. 11) and the outer distance D2 between the first end portion 291c and the second end portion 292c in the state that the coupling portion 290 is detached from the connector 180.

As examples shown in FIGS. 12 and 13, the restoring force providing portion 220 includes the plunger 240, but the disclosure is not limited thereto. Alternatively, the restoring force providing portion 220 may include a cantilever structure and/or a rubber member providing an elastic force, etc. to provide the restoring force to the razor cartridge 10.

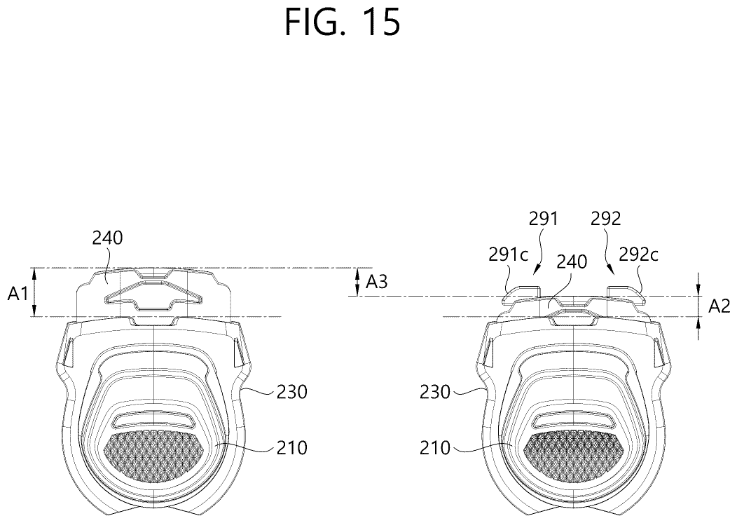

FIG. 15 is a view for comparison between the detached state and the coupled state with respect to the plunger according to an embodiment.

Referring to FIG. 15, in the state (detached state) that the razor handle 20 is completely detached from the razor cartridge 10, the front end of the plunger 240 is positioned to be spaced forward by A1 from the plunger housing 230. A1 may be 4.6 mm to 7.0 mm. More preferably, A1 may be 5.0 mm to 6.5 mm. The detached state may refer to a state that the plunger 240 is positioned at the forward limit point.

In the detached state, the elastic member 260 (see FIG. 5) elastically supporting the plunger 240 may be compressed to provide an elastic force (hereinafter referred to as a first preload) to the plunger 240. The elastic member 260 may have a spring constant of 80 to 220 gf/mm, more preferably 100 to 180 gf/mm, and the elastic member 260 in the detached state may have a compression displacement of 0.5 to 1.9 mm, more preferably 0.8 to 1.5 mm. The first preload may be 20 to 400 gf, more preferably 50 to 230 gf. According to an embodiment, the razor handle 20 may be configured to have a first preload of substantially 0 gf in the detached state.

Meanwhile, when the razor handle 20 and the razor cartridge 10 are coupled and the razor cartridge 10 is in the resting position (hereinafter referred to as a resting state), the front end of the plunger 240 is positioned to be spaced forward by A2 from the plunger housing 230. A2 may be 2.3 mm to 4.1 mm. More preferably, A2 may be 2.6 mm to 3.8 mm.

Referring to FIG. 15, the front end of the plunger 240 in the detached state is positioned in front of the front end of the plunger 240 in the resting state. A position difference A3 of the front end of the plunger 240 between the detached state and the resting state may be 1.5 mm to 3.5 mm. More preferably, A3 may be 2.0 mm to 3.2 mm.

Due to the position difference A3 in the front end of the plunger 240 tip between the detached state and the resting state, a user may visually check the position of the front end of the plunger 240 to recognize whether the razor cartridge 10 is installed or not and/or whether the razor cartridge 10 is installed properly.

Because the plunger 240 in the resting state is positioned behind that in the detached state, the elastic member 260 elastically supporting the plunger 240 is compressed by a larger compression displacement in the resting state than in the detached state. Therefore, an elastic force (hereinafter referred to as a second preload) provided to the plunger 240 by the elastic member 260 in the resting state is greater than the first preload.

In the resting state, the elastic member 260 may have a compression displacement of 2.2 to 5 mm, more preferably 3.0 to 4.4 mm. The second preload may be 250 to 730 gf, more preferably 400 to 650 gf.

As described above with reference to FIG. 9, in the razor assembly according to an embodiment of the disclosure, when the razor cartridge 10 is detached from the razor handle 20, the first end portion 291c and the second end portion 292c come closer to each other and are detached from the connector 180 of the razor cartridge 10 such that the razor cartridge 10 becomes detachable from the razor handle 20. In the process of detaching the razor cartridge 10 from the razor handle 20, the first end portion 291c and the second end portion 292c do not exert a force pushing the razor cartridge 10 from the razor handle 20.

Immediately after the first end portion 291c and the second end portion 292c are detached from the accommodating space 184 of the connector 180, the plunger 240 supporting the razor cartridge 10 is switched over from the resting state to the detached state by the elastic member 260. In this process, the plunger 240 provides an ejection load to the razor cartridge 10.

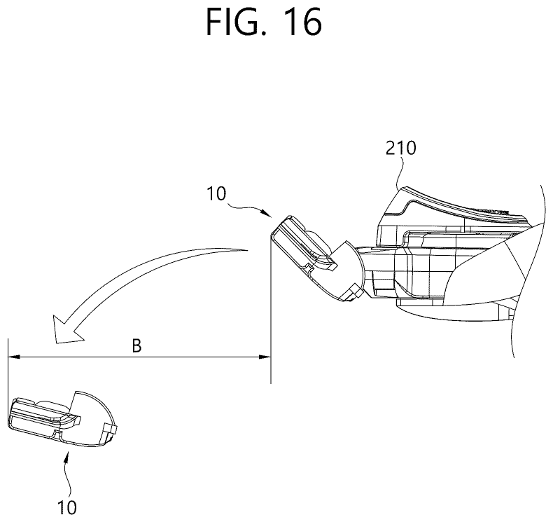

FIG. 16 is a view showing that a razor cartridge is ejected from a razor assembly according to an embodiment of the disclosure.

Referring to FIG. 16, the razor cartridge 10 is ejected forward from the razor handle 20 by the ejection load.

The ejection load is related to difference between the first preload and the second preload. Together with the difference between the first preload and the second preload, an additional elastic force, which is caused by the additional compressive displacement of the elastic member 260 (see FIG. 5) caused by the pusher 250 (see FIG. 5) moving toward the plunger 240 as a user operates the operating portion 210 (see FIG. 5) to detach the razor cartridge 10, may serve as the ejection load.

In this case, the ejection load may include the first ejection load based on the difference between the first preload and the second preload, and the second ejection load based on the additional elastic force of the elastic member 260 due to the movement of the operating portion 210 for detaching the razor cartridge 10.

To detach the razor cartridge 10, the moving distance of the operating portion 210 along the first direction may be 1.0 to 4.0 mm, and preferably 2.1 to 2.8 mm. When the operating portion 210 moves forward in the first direction, the second ejection load generated by the additional compressive displacement of the elastic member 260 may be 15 to 40 gf, and more preferably, 21 to 26 gf.

The ejection load may be 190 to 550 gf, more preferably 250 to 480 gf. The ejection load within such a numerical range is used in implementing an appropriate ejection distance B during the detachment process of the razor cartridge 10, providing an appropriate mounting feeling during the coupling process of the razor cartridge 10, and providing an effective restoring force for the razor cartridge 10.

If the ejection load is too small, the razor cartridge 10 falls almost vertically downward when detached from the razor handle 20. In this case, it is necessary to move the razor assembly vertically above a garbage can and then detach the razor cartridge 10 from the razor handle 20 to throw away the razor cartridge 10, which are inconvenient for a user.

Further, if the ejection load is too small, the plunger 240 has a weak restoring force to restore the razor cartridge 10 to the resting state, thereby lowering the close contact between the blade and the skin and the convenience of shaving.

On the other hand, if the ejection load is too large, it is difficult for a user to couple the razor cartridge 10 to the razor handle 20, and the razor cartridge 10 may fly excessively far during the detachment process when detaching the razor cartridge 10 from the razor handle 20 due to a very large ejection distance B of the razor cartridge 10, thereby resulting in unexpected injury or damage.

Meanwhile, among conventional razor assemblies, there is a type in which the razor cartridge and the razor handle are coupled using hook engagement. This type has a structure in which, when the razor is pushed using a push bar provided on the razor handle, a hook structure provided in either the razor cartridge or the razor handle is elastically deformed to release the hook engagement.

Therefore, when a user pushes the push bar to detach the razor cartridge, it is difficult to precisely determine the force required for the elastic deformation of the hook structure to release the hook engagement, and it is difficult to predict the timing when the razor cartridge is detached as the hook engagement is released while the push bar is being pushed. Further, it is also difficult to predict how far the razor cartridge will be ejected from the handle when detach.

On the other hand, in the razor assembly according to an embodiment of the disclosure, the detachment of the razor cartridge 10 from the razor handle 20 is achieved not by the elastic deformation of the arms 291 and 292 but rather by the disengagement of the first end portion 291c and the second end portion 292c from the accommodating space 184 as the arms 291 and 292 rotate.

Therefore, compared to the conventional razor assembly, less force is required to detach the razor cartridge, and it is sufficiently possible to predict the detaching timing of the razor cartridge.

Further, in the process of detaching the razor cartridge 10 from the razor handle 20, the ejection load by the plunger 240 acts as a force that pushes the razor cartridge 10 away from the razor handle 20, and it is thus possible to design an appropriate ejection distance B for the razor cartridge 10 by adjusting the ejection load.

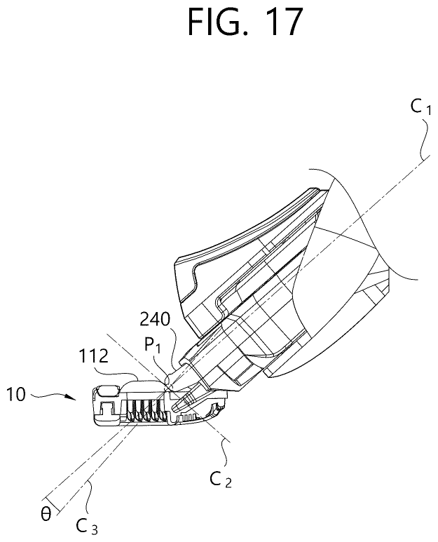

FIG. 17 is a view for comparison between an ejecting direction of a razor cartridge and a sliding direction of a plunger in a razor assembly according to an embodiment of the disclosure

Referring to FIG. 17, C1 denotes the sliding direction of the plunger 240, C2 denotes a tangential direction at a support point P1 where the plunger 240 is in contact with the cam 112 in the resting state, and C3 denotes a direction perpendicular to the tangential direction at the support point P1.

When the razor cartridge 10 is detached in the resting state, the razor cartridge 10 is ejected in a direction perpendicular to the tangent direction at the support point P1, i.e., in the direction C3.

Referring to FIG. 15, in the razor assembly according to this embodiment, the shape of the front end of the plunger 240 and/or the cam 112 may be determined so that the direction C3 can form an acute angle θ downward to the direction C1. The downward direction may refer to a direction in which the blade of the razor cartridge 10 is exposed. The acute angle θ may be 1 degree to 15 degrees, more preferably 3 degrees to 7 degrees.

This allows the razor cartridge 10 to be ejected downwards, allowing for safer ejection of the razor cartridge 10.

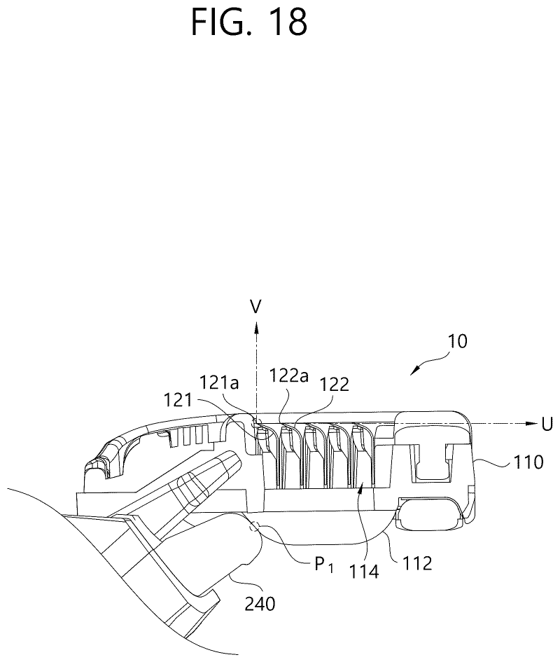

FIG. 18 is a view for describing the position of a plunger, which is varied depending on a pivot angle of a razor cartridge, in a razor assembly according to an embodiment of the disclosure.

Referring to FIG. 18, ‘U’ denotes the rearward direction of the razor cartridge 10, and ‘V’ denotes the upward direction of the razor cartridge 10, with respect to the cutting edge 121a of the frontmost blade 121 based on the shaving direction among the plurality of blades.

The cam 112 is formed below a blade accommodating space 114 in which the plurality of blades are accommodated, and the support point P1 is also formed below the blade accommodating space 114.

In the detached state and the coupled state of the razor cartridge 10, the positions of the support point P1 in a UV coordinate system depending on the pivot angles of the razor cartridge 10 are as shown in [Table 1] or [Table 2] below.

TABLE 1

| | | Coupled state | | | |
|---|---|---|---|---|---|
| | Detached | 0 degrees | Pivoted at 15 | Pivoted at 30 | Pivoted at 45 |
| Directions | state | (resting) | degrees | degrees | degrees |
| U | −0.5 to +1.0 mm | −0.5 to +1.0 mm | −0.3 to +1.2 mm | +0.1 to +1.6 mm | +0.6 to +2.1 mm |
| V | −5.3 to −3.4 mm | −5.3 to −3.4 mm | −5.4 to −3.5 mm | −5.6 to −3.7 mm | −5.8 to −3.8 mm |

TABLE 2

| | | Coupled state | | | |
|---|---|---|---|---|---|
| | Detached | 0 degrees | Pivoted at 15 | Pivoted at 30 | Pivoted at 45 |
| Directions | state | (resting) | degrees | degrees | degrees |
| U | −0.3 to +0.5 mm | −0.3 to +0.5 mm | −0.1 to +0.7 mm | +0.3 to +1.3 mm | +0.5 to +1.9 mm |
| V | −4.9 to −3.9 mm | −4.9 to −3.9 mm | −5.1 to −4.0 mm | −5.3 to −4.1 mm | −5.5 to −4.0 mm |

In the foregoing [Table 1] and [Table 2], an angle of 45 degrees is merely an exemplary value of the maximum pivot angle, and the disclosure is not limited thereto. Further, in the foregoing [Table 1] and [Table 2], angles of 15 degrees and 30 degrees are also exemplary angles for representing ⅓ and ⅔ of the maximum pivot angle, and the disclosure is not limited thereto. However, for the convenience of description, the state of being pivoted by 45 degrees will be referred to as the maximum pivot angle in the following description.

In the resting state, the support point P1 may be located in front of the cutting edge 121a of the first razor blade 121 or in front of the cutting edge 122a of the second razor blade 122 with respect to the shaving direction.

In the maximum pivot state (the state of being pivoted by 45 degrees), the support point P1 may be located behind the cutting edge 121a of the first razor blade 121 or behind the cutting edge 122a of the second razor blade 122 with respect to the shaving direction.

A moving distance of the support point P1 from the resting state to the maximum pivot state in the U direction may be 0.8 mm or more, or 1.0 mm or more.

In the razor assembly according to this embodiment, the support point P1 in the maximum pivot state is located adjacent to the rear of the cutting edge 121a of the first razor blade 121 or the cutting edge 122a of the second razor blade 122.

Accordingly, the retreat distance of the plunger 240 becomes longer as the razor cartridge 10 pivots, thereby providing a sufficient restoring force to restore the razor cartridge 10 to the resting state, and continuously increasing the restoring force of the plunger 240 with the increased pivot angle of the razor cartridge 10.

Further, in the resting state, the support point P1 is located in front of the cutting edge 121a of the first razor blade 121 or in front of the cutting edge 122a of the second razor blade 122, and thus no obstacles are present at the rear of most blades, thereby allowing cleaning water to easily pass through the blade accommodating space 114 and be discharged to the rear during the process of cleaning the razor cartridge 10.

Meanwhile, in the razor assembly according to this embodiment, the plunger 240 may be configured to support both longitudinal sides of the blade housing 110 with respect to the support point P1 in order to prevent the razor cartridge 10 from being ejected pivoting excessively and during the ejection of the razor cartridge 10. In this case, when the razor cartridge 10 is ejected, the plunger 240 pushes both longitudinal sides of the blade housing 110 simultaneously, so that the razor cartridge 10 can be ejected without pivoting toward the front of the razor handle 20. Further, even though one of the end portions 291c and 292c of the arms 291 and 292 is first disengaged from the accommodating space 184 during the detachment process or by an external force, the plunger 240 simultaneously pushes both longitudinal sides of the blade housing 110 with respect to the support point P1, thereby preventing the razor cartridge 10 from being ejected pivoting excessively.

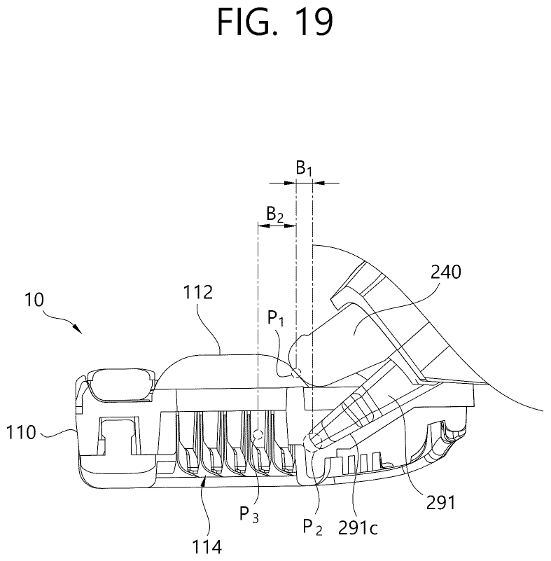

FIG. 19 is a view for describing the pivot center, center of gravity, and support point of a razor cartridge in a razor assembly according to an embodiment of the disclosure.

Referring to FIG. 19, the pivot center P2 of the razor cartridge 10 is formed adjacent to the end portions 291c and 292c of the arms 291 and 292. The pivot center P2 of the razor cartridge 10 refers to a point through which the pivot axis of the razor cartridge 10 about the razor handle passes. In addition, the support point P1 of the plunger 240 may be located between the center of gravity P3 of the razor cartridge 10 and the pivot center P2 along the transverse direction of the razor cartridge 10.

A transverse space B1 between the support point P1 and the pivot center P2 may be 0.8 to 1.7 mm, and preferably 1.0 to 1.5 mm.

A transverse space B2 between the support point P1 and the center of gravity P3 may be 0.2 to 2.0 mm, and preferably 0.6 to 1.3 mm.

Because the support point P1 of the plunger 240 is located between the center of gravity P3 and the pivot center P2, the restoring force by the plunger 240 and the restoring force by the weight of the razor cartridge 10 generate a pivot torque in the same direction about the pivot center P2 when the razor cartridge 10 is restored to the resting state, thereby improving the restoring performance of the razor cartridge 10 to the resting state.

When the distance between the support point P1 of the plunger 240 and the center of gravity P3 of the razor cartridge 10 is large, the ejection load by the plunger 240 acts in a different direction from the center of gravity P3 of the razor cartridge 10 and causes a pivot motion, etc. in the razor cartridge 10 during the ejection of the razor cartridge 10, so that the ejection load cannot be fully used for the ejection of the razor cartridge 10.

According to this embodiment, because the support point P1 of the plunger 240 and the center of gravity P3 of the razor cartridge 10 are positioned adjacent to each other, the ejection load by the plunger 240 acts toward the center of gravity P3 of the razor cartridge 10, so that the ejection load can be fully used for the ejection of the razor cartridge 10, thereby preventing the razor cartridge 10 from rotating and flying away after the ejection.

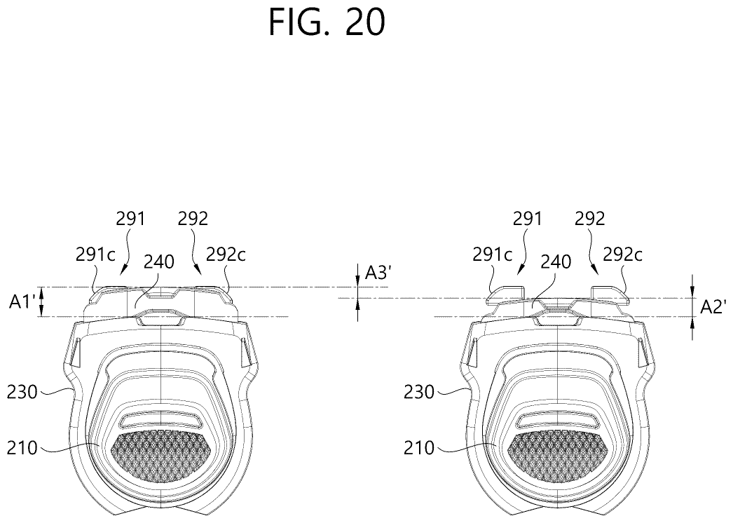

FIG. 20 is a view for comparison between a detached state and a coupled state of another embodiment of a plunger according to an embodiment of the disclosure.

In the embodiment described with reference to FIG. 15, the plunger 240 is positioned to cover an upper side of the first arm 291 and the second arm 292 so that the first arm 291 and the second arm 292 cannot be exposed upward in the detached state.

On the other hand, in the embodiment shown in FIG. 20, the plunger 240 is positioned to expose at least a portion of the first arm 291 and the second arm 292 to the outside of the plunger 240.

Referring to FIG. 20, at least a portion of the end portions 291c and 292c of the first and second arms 291 and 292 may be exposed to the outside in the detached state when viewed from above the plunger 240. In other words, at least a portion of the end portions 291c and 292c of the first and second arms 291 and 292 may be positioned in front of or outside the plunger 240 in the detached state, so that a user can easily recognize the presence of the arms 291 and 292 and accurately couple the razor handle and the razor cartridge.

Referring to FIG. 20, the front end of the plunger 240 in the detached state is positioned to be spaced forward by A1′ from the plunger housing 230. A1′ may be 2.8 mm to 5.3 mm. More preferably, A1′ may be 3.6 mm to 4.5 mm.

The compression displacement of the elastic member 260 in the detached state according to this embodiment may be 0.83 to 1.53 mm, more preferably 1.06 to 1.30 mm. The first preload may be 130 to 740 gf, more preferably 150 to 630 gf.

Because the elastic member 260 (see FIG. 5) elastically supporting the plunger 240 in the detached state according to this embodiment is more compressed than that in the detached state illustrated in FIG. 15, the first preload greater than that of the embodiment described with reference to FIG. 15 is provided.

Meanwhile, referring to FIG. 20, the front end of the plunger 240 in the resting state is positioned to be spaced forward by A2′ from the plunger housing 230. A2′ may be 2.2 mm to 4.5 mm. More preferably, A2′ may be 2.4 mm to 3.9 mm.

The compression displacement of the elastic member 260 in the resting state according to this embodiment may be 2.50 to 4.64 mm, more preferably 3.21 to 3.93 mm. The second preload may be 260 to 830 gf, more preferably 440 to 710 gf.

Referring to FIG. 20, the front end of the plunger 240 in the detached state is positioned in front of the front end of the plunger 240 in the resting state. A position difference A3′ in the front end of the plunger 240 between the detached state and the resting state may be 0.2 mm to 1.8 mm. More preferably, A3′ may be 0.4 mm to 1.3 mm.

The ejection load according to this embodiment is also related to the difference between the first preload and the second preload. Further, the ejection load according to this embodiment may also include the first ejection load based on the difference between the first preload and the second preload, and the second ejection load based on the additional elastic force of the elastic member 260 due to the movement of the operating portion 210 for the detachment of the razor cartridge 10.

The ejection load according to this embodiment may be 50 to 200 gf. More preferably, the ejection load may be 71 to 131 gf, even more preferably 91 to 111 gf.

According to this embodiment, even in the detached state, a user may easily check the presence of the first arm 291 and the second arm 292, thereby improving a user's recognition for the attachment/detachment of the razor cartridge 10.

Further, compared to the embodiment illustrated in FIG. 15, the first preload is increased to improve the restoring force that restores the razor cartridge 10 to the resting state during shaving, thereby improving the close contact between the razor cartridge 10 and the skin, and allowing for a cleaner shave.

Further, compared to the embodiment illustrated in FIG. 15, the ejection load is reduced, thereby providing a smoother mounting feel when coupling the razor cartridge 10.

A person having ordinary knowledge in the art to which the disclosure pertains will appreciate that the disclosure may be implemented in other specific forms without changing the technical spirit or essential features thereof. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor handle, to which a razor cartridge comprising at least one blade formed with a cutting edge, accommodating the blade in a longitudinal direction, and provided with a connector on one side thereof is detachably coupled, the razor handle comprising:
first and second arms spaced apart from each other in the longitudinal direction, coupled to the connector as moving away from each other, and detached from the connector as moving closer to each other; and
a restoring force providing portion configured to provide a restoring force against pivoting of the razor cartridge,
wherein the restoring force providing portion is configured to provide an ejection load to the razor cartridge in a state that the razor cartridge is coupled to the razor handle in a resting state, and
wherein the razor cartridge is configured to be ejected from the razor handle based on the ejection load provided to the razor cartridge by the restoring force providing portion as the first arm and the second arm are moving closer to each other and detach from the connector.

2. The razor handle of claim 1, wherein the ejection load is based on a difference between:
a first preload that is an elastic force acting on the restoring force providing portion in a state that the razor cartridge is not coupled to the razor handle, and
a second preload that is an elastic force acting on the restoring force providing portion in the state that the razor cartridge is coupled to the razor handle in the resting state.

3. The razor handle of claim 1, further comprising an elastic member that elastically supports the restoring force providing portion to provide the restoring force, and provides an additional elastic force by operating the first arm and the second arm so that the first arm and the second arm can be detached from the connector,
wherein the ejection load comprises:
a first ejection load based on difference between a first preload that is an elastic force acting on the restoring force providing portion in the state that the razor cartridge is not coupled to the razor handle, and a second preload that is an elastic force acting on the restoring force providing portion in the state that the razor cartridge is coupled to the razor handle in the resting state; and
a second ejection load based on the additional elastic force.

4. The razor handle of claim 1, wherein a front end of the restoring force providing portion in the state that the razor cartridge is not coupled to the razor handle is positioned in front of the front end of the restoring force providing portion in the state that the razor cartridge is coupled to the razor handle in the resting state.

5. The razor handle of claim 4, wherein:
the restoring force providing portion is positioned above the first arm and the second arm,
the restoring force providing portion is disposed to cover an upper side of the first arm and the second arm so as not to be exposed upward in the state that the razor cartridge is not coupled to the razor handle.

6. The razor handle of claim 1, wherein the ejection load is 190 gf to 550 gf.

7. The razor handle of claim 1, wherein a position difference between a front end of the restoring force providing portion in the state that the razor cartridge is not coupled to the razor handle and the front end of the restoring force providing portion in the state that the razor cartridge is coupled to the razor handle in the resting state is 1.5 mm to 3.5 mm.

8. The razor handle of claim 7, wherein:
the restoring force providing portion comprises a plunger that moves forward and backward providing the restoring force,
the razor handle further comprises a plunger housing that accommodates the plunger therein so that the plunger can move forward and backward with an exposed front end of the plunger,
the front end of the plunger is positioned 4.6 mm to 7.0 mm forward of the plunger housing in the state that the razor cartridge is not coupled to the razor handle, and
the front end of the plunger is positioned 2.3 mm to 4.1 mm forward of the plunger housing in the state that the razor cartridge is coupled to the razor handle in the resting state.

9. The razor handle of claim 4, wherein the restoring force providing portion is positioned so that at least a portion of the first arm and the second arm can be exposed to the outside of the restoring force providing portion in the state that the razor cartridge is not coupled to the razor handle.

10. The razor handle of claim 9, wherein the ejection load is 50 gf to 200 gf.

11. The razor handle of claim 9, wherein a position difference between the front end of the restoring force providing portion in the state that the razor cartridge is not coupled to the razor handle and the front end of the restoring force providing portion in the state that the razor cartridge is coupled to the razor handle in the resting state is 0.2 mm to 1.8 mm.

12. The razor handle of claim 11, wherein:
the restoring force providing portion comprises a plunger that moves forward and backward providing the restoring force,
the razor handle further comprises a plunger housing that accommodates the plunger therein so that the plunger can moves forward and backward with an exposed front end of the plunger,
the front end of the plunger is positioned 2.8 mm to 5.8 mm forward of the plunger housing in the state that the razor cartridge is not coupled to the razor handle, and
the front end of the plunger is positioned 2.2 mm to 4.5 mm forward of the plunger housing in the state that the razor cartridge is coupled to the razor handle in the resting state.

13. A razor assembly comprising a razor cartridge, and a razor handle to which the razor cartridge is detachably coupled,
wherein the razor cartridge comprises
a plurality of blades formed with cutting edges, and
a blade housing accommodating the plurality of blades in a longitudinal direction, and provided with a connector on one side thereof, and
wherein the razor handle comprises:
first and second arms spaced apart from each other in the longitudinal direction, coupled to the connector as moving away from each other, and detached from the connector as moving closer to each other; and
a restoring force providing portion configured to provide a restoring force against pivoting of the razor cartridge,
wherein the restoring force providing portion is configured to provide an ejection load to the razor cartridge in a state that the razor cartridge is coupled to the razor handle in a resting state, and
wherein the razor cartridge is configured to be ejected from the razor handle based on the ejection load provided to the razor cartridge by the restoring force providing portion as the first arm and the second arm are moving closer to each other and detached from the connector.

14. The razor assembly of claim 13, wherein a pivot center of the blade housing is positioned forward of the frontmost blade in a shaving direction among the plurality of blades.

15. The razor assembly of claim 13, wherein:
the blade housing comprises a blade accommodating space to accommodate the plurality of blades therein, and
a support point at which the blade housing is in contact with the restoring force providing portion is formed below the blade accommodating space.

16. The razor assembly of claim 15, wherein a direction perpendicular to a tangent at the support point between the blade housing and the restoring force providing portion forms an acute angle with a sliding direction of the restoring force providing portion.

17. The razor assembly of claim 15, wherein the support point is located between the pivot center of the blade housing and the center of gravity of the razor cartridge along a transverse direction of the razor cartridge.
